(19) United States
(12) Patent Application Publication
(10) Pub. No.: US 2003/0233994 A1
(43) Pub. Date: Dec. 25, 2003

(54) FUEL INJECTION SYSTEM FOR AN INTERNAL COMBUSTION ENGINE

(75) Inventor: Anders Larsson, Lerum (SE)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO LASTVAGNAR AB, Goteborg (SE)

(21) Appl. No.: 10/250,261

(22) Filed: Jun. 18, 2003

Related U.S. Application Data
(60) Provisional application No. 60/389,737, filed on Jun. 19, 2002.

(51) Int. Cl. F02B 77/00

(52) U.S. Cl. 123/198 E

(57) ABSTRACT

Method and arrangement for a fuel system for an internal combustion engine (10) including a fuel tank (13), a fuel pump (12) and a fuel filter (19) located in a flow duct (14) between the fuel pump and the fuel consumers (11) of the engine. The flow duct (14) includes a valve chamber (20), located downstream of the fuel filter, with a valve cone (24) arranged movably in said chamber between an upper valve seat (20b) and a lower valve seat (27). The upper part of the valve chamber (20) has an outlet (22) for bleeding to the fuel tank (13). The valve cone (24) is provided with an inner passage (25) with a valve seat (25a) which, under normal fuel pressure, interacts with a bleed cone (26) which is movable in the passage.

### CROSS REFERENCE TO RELATED APPLICATIONS

The present patent application claims the benefit of U.S. Provisional Patent Application No. 60/389,737 filed Jun. 19, 2002.

### BACKGROUND OF INVENTION

1. Technical Field

The present invention relates to a fuel system for an internal combustion engine that has, in association therewith, a fuel tank, a fuel pump and a fuel filter that is located in a flow duct between the fuel pump and the fuel consuming components of the engine. The flow duct includes a valve chamber, located downstream of the fuel filter, with a valve cone movably arranged in the chamber between an upper valve seat and a lower valve seat.

2. Background of the Invention

Fuel systems for internal combustion engines are conventionally designed in such a way that exchanging a fuel filter involves emptying the fuel line between the outlet of the filter housing and the cylinder head. In this connection, the environmentally harmful substance (fuel) should be collected to avoid spillage. Exchanging a fuel filter is a common service action, especially on heavy diesel engines. It is usual for fuel systems of diesel engines to be provided with a bleed nipple and a hand pump that can be used when air bleeding and refilling of fuel is carried out. Before the engine is next started, however, a large number of strokes of the hand pump it typically required, and it is necessary to open one or more bleed nipples in order to remove the significant quantity of air that is present in the new filter. This involves expensive workshop time and also a risk of fuel spillage because the abovementioned nipples are generally not closed before the fuel flows.

There are fuel systems with devices for automating the procedure for removing air as disclosed in U.S. Pat. No. 5,534,161. Therein, a pump is described that can be driven in two directions by means of a microprocessor, and that can be used for removing water from a fuel system. This device, however, can only facilitate the procedure for bleeding air from the fuel system, and further actions are required in order to remove air from the high-pressure side of the system. Inclusion of this device therefore means that the number of components in the fuel system increases without fully solving the problem of facilitating the bleed procedure.

### SUMMARY OF INVENTION

One objective of the invention is to provide a fuel system that enables automated removal of air, after filter exchange, without adding further complication or expense.

The fuel system design comprises (includes, but is not limited to) a fuel tank, a fuel pump and a fuel filter located in a flow duct between the fuel pump and the fuel consumers of the engine. An example of such fuel consumers is the piston and chamber arrangement which burns fuel. The flow duct includes a valve chamber, located downstream of the fuel filter, with a valve cone arranged movably therein between an upper valve seat and a lower valve seat. An upper part of the valve chamber has an outlet for bleeding to the fuel tank, and the valve cone is provided with an inner passage having a valve seat, that, under normal fuel pressure, interacts with a bleed cone which is movable in the passage. On the one hand, this design of the fuel system ensures that fuel spillage during filter exchange is minimized, and, on the other hand, the subsequent bleeding of the fuel system can take place automatically.

### BRIEF DESCRIPTION OF DRAWINGS

The invention will be described in greater detail below with reference to illustrative embodiments shown in the accompanying drawings, in which:

FIG. 1 is a diagrammatical view of an internal combustion engine with a fuel system configured according to the teachings of the present invention;

FIG. 2 is a more detailed view of a filter holder, forming part of the fuel system of FIG. 1, with an associated filter; and

FIGS. 3-5 are diagrammatical views, in further enlarged scale, of three different functional states of a valve chamber forming part of the disclosed fuel system.

### DETAILED DESCRIPTION

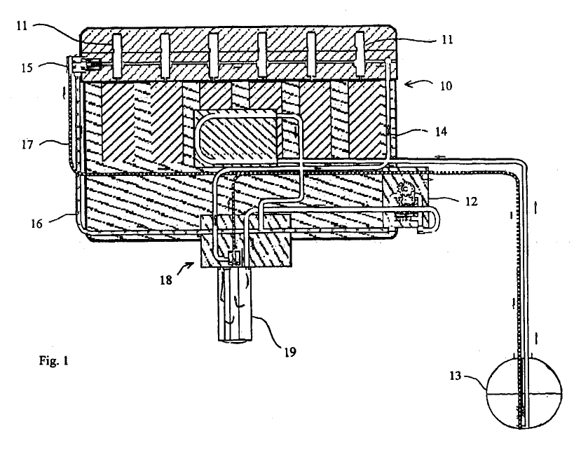

The internal combustion engine 10 shown diagrammatically in FIG. 1 is a 6-cylinder diesel engine with a corresponding number of standard type injectors 11. Exemplarily, the engine 10 can be used to power a heavy truck.

Diesel fuel is fed by a pump 12, driven by the engine 10, from a tank 13, via a common feeder line 14, to the injectors 11. A combination valve 15 for pressure control and bleeding is mounted downstream of the injectors 11. A return line 16 for uncombusted fuel is connected to the combination valve. A bleed line 17 is also connected to the combination valve, and which is in communication with the fuel tank 13.

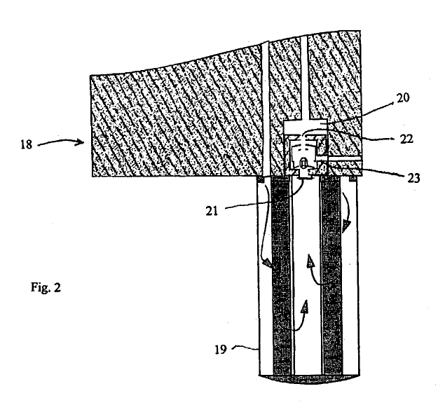

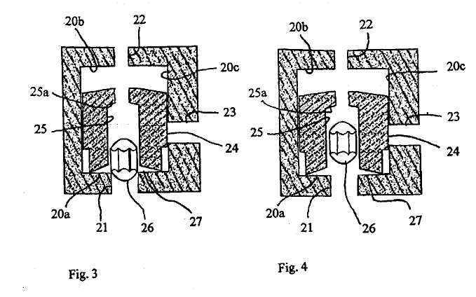

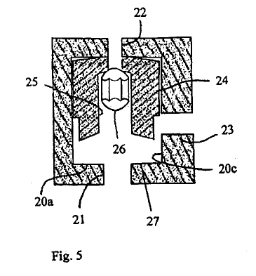

The fuel system also comprises a filter holder 18 with a fuel filter 19. The filter holder 18 is shown in detail in FIG. 2 and is provided with a cylindrical valve chamber 20 located downstream of the fuel filter as illustrated in greater detail in FIGS. 3-5. The lower end wall 20a of the chamber is provided with a central inlet 21 from the fuel filter 19. Via a central outlet 22, the upper end wall 20b communicates with the fuel tank 13 via the bleed line 17. The valve chamber also communicates with the feeder line 14 via a laterally directed outlet 23 arranged in the lateral surface 20c.

The valve chamber 20 accommodates a valve cone 24 which is provided with an inner passage 25 having a valve seat 25a and a bleed cone 26 which is movable in the passage 25. The bleed cone 26 is arranged to interact with the lower valve seat 27 of the valve chamber at low fuel pressure as depicted in FIG. 3. As utilized herein, components that are described as being arranged to interact means the so-described components are adapted to sealingly engage when abutting one another. As the fuel pressure increases, the bleed cone, which is considerably more freely moving than the valve cone 24, can remove itself from the valve seat 27, air bubbles then being able to move past the bleed cone and out via the bleed port 22 as shown in the configuration of FIG. 4. When the fuel pressure (from below) is sufficiently high, the bleed cone 26 interacts with the valve seat 25a and the valve cone 24 is then moved from the valve seat 27 so that fuel can pass out through the outlet 23 to the feeder line 14.

When the engine is started after an exchange of the fuel filter 19, the fuel pump 12 sucks fuel from the tank 13 and fills the filter 19. When pressure in the filter has become sufficiently great, the bleed cone 26 is lifted from the valve seat 27 and air can pass through the passage 25 past the bleed cone and on through the outlet 22. When the fuel reaches the valve chamber 20, the bleed cone will close the valve seat 25a, the valve cone 24 then being displaced upward and air-free fuel starting to be pushed to the consumers 11 of the engine via the outlet 23 to the feeder line 14.

The weight of the bleed cone 26 is adapted in such a way that air bubbles in the fuel easily cause it to lift from the lower valve seat 27. The weight of the valve cone 24 is in turn adapted in such a way that only the fuel pressure is capable of causing it to lift from the lower valve seat 27.

Since the bleed cone 26 serves as a non-return valve, and can rapidly close the inlet 21, a large part of the positive pressure in the feeder line 14 can be retained during filter exchange. This positive pressure constitutes a prerequisite for the engine starting and continuing to run for the time it takes before all the air has passed out through the bleed port 22, after which the incoming fuel pressure can rise to the normal level which is maintained by the combination valve 15. The engine, therefore, runs even during the bleeding process because fuel still remains around the injectors 11 and in the fuel line 14 leading thereto. It should be pointed out that this assumes that the engine is running under low load; that is to say, with low fuel consumption thereby it possible for the pump to replace the air quantity present in the filter with fuel. Moreover, this bleeding process takes only about ten seconds.

The invention is not to be regarded as being limited to the illustrative embodiments described above, but a number of further variants and modifications are conceivable within the scope of the following patent claims. It is possible, for example, to use spring means which act in the closing direction as a supplement to the weight of the valve cone 24 and/or the bleed cone 26.

1. A fuel system for an internal combustion engine, said system comprising:
a fuel tank, a fuel pump and a fuel filter located in a flow duct between the fuel pump and a fuel consumer of the engine;
the flow duct comprises a valve chamber, located downstream of the fuel filter, with a valve cone arranged movably in said valve chamber between an upper valve seat and a lower valve seat; and
an upper part of the valve chamber having an outlet for bleeding to the fuel tank, and the valve cone comprising an inner passage having a valve seat configured to interact with a bleed cone that is movable in the inner passage under normal fuel pressure.

2. The fuel system as recited in claim 1, wherein the bleed cone is arranged to interact with the lower valve seat of the valve chamber during low the fuel pressure.

3. The fuel system as recited in claim 2, wherein the bleed cone is arranged to move from the lower valve seat during bleeding, as the fuel pressure rises.

4. The fuel system as recited in claim 1, wherein the valve chamber is cylindrical and has a lower end wall having a central inlet in fluid communication with the fuel filter.

5. The fuel system as recited in claim 4, wherein the valve chamber is provided with an upper end wall having a central outlet in fluid communication with the fuel tank.

6. The fuel system as recited in claim 4, wherein a lateral surface of the valve chamber is provided with a laterally directed outlet in fluid communication with the fuel consumer of the engine.

7. The fuel system as recited in claim 1, wherein a weight of the bleed cone is adapted so that air bubbles in the fuel are capable of causing the the bleed cone to lift away from the lower valve seat.

8. The fuel system as recited in claim 1, wherein a weight of the valve cone is adapted so that air bubbles in the fuel are capable of causing the the valve cone to lift away from the lower valve seat.

9. The fuel system as recited in claim 1, further comprising:
a spring engaging the valve cone that biases the valve cone toward a closed configuration.

10. The fuel system as recited in claim 1, wherein the bleed cone is biased by a spring toward a closed configuration.

11. The fuel system as recited in claim 1, wherein the valve chamber is located in a filter holder proximate a connection for the fuel filter.

12. A method for providing a self-bleeding filtered fuel system for an internal combustion engine, said method comprising:
providing a fuel system for an internal combustion engine having a fuel tank, a fuel pump and a fuel filter that is located in a flow duct between the fuel pump and a fuel consumer of the engine;
including, along the flow duct downstream of the fuel filter, a valve chamber containing a valve cone reciprocatingly arranged between an upper valve seat and a lower valve seat;
providing an outlet in fluid communication with the valve chamber for bleeding non-consumed fuel back to the fuel tank; and
providing the valve cone with an inner passage having a valve seat which, under normal fuel pressure, interacts with a bleed cone adapted for reciprocating motion in the passage.

13. The method as recited in claim 12, further comprising:
locating the outlet in fluid communication with an upper part of the valve chamber.

14. The method as recited in claim 12, further comprising:
arranging the bleed cone to interact with the lower valve seat of the valve chamber when fuel pressure is low.

15. The method as recited in claim 12, further comprising:
arranging the bleed cone to move from the lower valve seat during bleeding, as fuel pressure rises.

16. The method as recited in claim 12, further comprising:
cylindrically configuring the valve chamber with a lower end wall having a central inlet from the fuel filter.

17. The method as recited in claim 16, further comprising:
providing the valve chamber with an upper end wall having a central outlet to the fuel tank.

18. The method as recited in claim 16, further comprising:
providing the lateral surface of the valve chamber with a laterally directed outlet to the fuel consumers of the engine.

19. The method as recited in claim 12, further comprising:
adapting the weight of the bleed cone so that fuel air bubbles cause the bleed cone to lift from the lower valve seat.

20. The method as recited in claim 12, further comprising:
selecting the bleed cone to have a weight that permits fuel air bubbles to cause the bleed cone to lift from the lower valve seat.

21. The method as recited in claim 12, further comprising:
adapting the weight of the valve cone so that fuel pressure causes the valve cone to lift from the lower valve seat.

22. The method as recited in claim 12, further comprising:
selecting the valve cone to have a weight that permits fuel pressure to cause the valve cone to lift from the lower valve seat.

23. The method as recited in claim 12, further comprising:
spring-biasing the valve cone toward a closed configuration.

24. The method as recited in claim 12, further comprising:
spring-biasing the bleed cone toward a closed configuration.

25. The method as recited in claim 12, further comprising:
locating the valve chamber in a filter holder proximate to a connection for the fuel filter.
